(19) United States
(12) Patent Application Publication
(10) Pub. No.: US 2007/0111190 A1
(43) Pub. Date: May 17, 2007

(54) Data Transformation And Analysis

(76) Inventors: Mark N. Cohen, Thousand Oaks, CA (US); John Reese, Los Angeles, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/622,441

(22) Filed: Jan. 11, 2007

Related U.S. Application Data
(63) Continuation-in-part of application No. 10/990,911, filed on Nov. 16, 2004.

(51) Int. Cl. G09B 3/00

(52) U.S. Cl. 434/350

(57) ABSTRACT

Record transfer is described herein. At least one record in a first format may be received over a network from a record holder. Material data may be extracted from the at least one record. Specialized operations and analysis may be performed on the extracted material data. The record may be transformed into an output record, wherein the output record includes additional data resulting from the specialized operations and analysis. The output record may be delivered to a recipient.

### RELATED APPLICATION INFORMATION

This patent is a continuation-in-part of U.S. application Ser. No. 10/990,911, filed Nov. 16, 2004, entitled “Record Transfer”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field

The invention relates to record transfer.

2. Description of the Related Art

High school students apply to college, jobs, and for scholarships. College students apply to graduate school and for scholarships and jobs. Colleges, and graduate schools typically require official transcripts as part of an application to the school; and employers, scholarship funds and other destinations sometimes require official transcripts as well. An official transcript is a record that is verified to be authentic and accurate by the high school or college.

Typically, the information included in a transcript may include a student's grades and classes, grade point average, gender, birth place, student identification number, graduating year, school name, school address, and comments. When applying for college, graduate school, a scholarship, or a job, a student may request that a high school or college mail an official transcript to specified schools or potential employers.

Similarly, when applying for a job, an employer may require medical information. When applying for a loan, a lender may require financial records.

### DESCRIPTION OF THE DRAWINGS

FIG. 1 is a block diagram of an environment of a record transfer system.

FIG. 2 is flow chart of the actions taken by a record transfer system server.

FIG. 3 is flow chart of the actions taken by a record transfer system server in processing payment and/or accounting information.

FIG. 4 is flow chart of the actions taken by a record transfer system server receiving a group of records.

FIG. 5 is a flow chart of the actions taken by a record transfer system server performing specialized operations and analysis.

FIG. 6 is a flow chart of the actions taken to map records.

FIG. 7 is a flow chart of the actions taken by a record transfer system server.

FIG. 8 is a flow chart of the actions taken by a record transfer system server.

### DETAILED DESCRIPTION OF THE INVENTION

Throughout this description, the embodiments and examples shown should be considered as exemplars, rather than limitations on the invention.

Systems

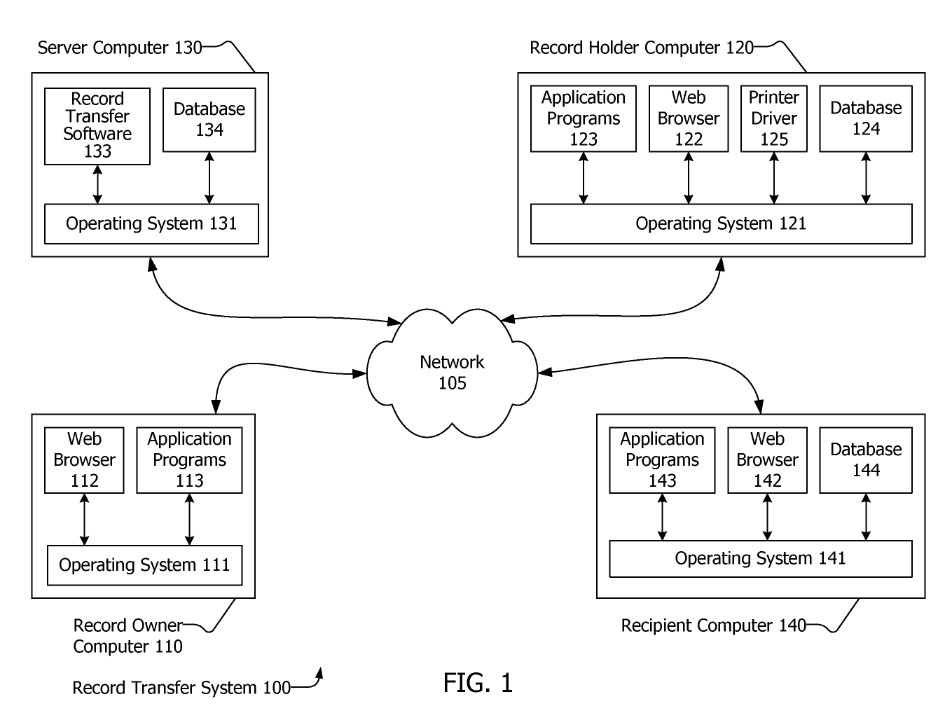

Referring now to FIG. 1, FIG. 1 is a block diagram of an environment of a record transfer system 100. The record transfer system 100 may include a record owner computer 110, a record holder computer 120, a server computer 130, a recipient computer 140 and a network 105.

As used herein, a record is a document or file that includes information. A record may be in electronic or hard copy format, may be printed on paper, viewable on a display and/or stored on a machine readable medium. Records include, for example, without limitation, school transcripts, medical information, loan documents, and property purchase transactional documents.

In one embodiment, the record transfer system 100 may be used to facilitate the transfer of school transcripts from one school to another school or from a school to any destination (such as a potential employer). In this embodiment, the record owner is a student or a former student who uses the record owner computer 110 to request a record transfer system associated with server computer 130 to obtain a school transcript from a school and provide it to another school or other destination (such as a potential employer). In this embodiment, the record holder computer 120 is used or accessed by a school such as a high school or university, and the recipient computer 140 is used or accessed by a school such as a university or any potential entity receiving transcripts.

In another embodiment, the record transfer system 100 may be used to facilitate transfer of any records between two entities at the request of a record owner. In these embodiments, the record owner using the record owner computer 110 may be a potential employee, a loan applicant, a property owner, a car buyer, a medical patient, and others; the record holder using or accessing record holder computer 120 may be a medical doctor, a medical care provider, a hospital, an insurance company, a bank, a credit agency, a government agency or other person or entity; the recipient using or accessing the recipient computer 140 may be a potential employer, a bank, a hospital, an insurance company, a title company, a lender, a seller, or other person or entity.

The hardware and software of the record transfer system 100 and its functions may be distributed such that some aspects are performed by each of the record owner computer 110, the record holder computer 120, the server computer 130, and the recipient computer 140. Because each of the record owner, record holder and recipient may require the record transfer server 130 to keep records and billing information confidential and to receive and transmit information securely, communications between the record owner computer 110, the record holder computer 120 and the recipient computer on the one hand with the server 130 on the other hand may be over secure links. In another embodiment, the record owner computer 110, the record holder computer 120, the server computer 130, and the recipient computer 140 may communicate using regular or not secure connections, and the file transmitted between the entities may be separately encrypted and decrypted.

Although only one each of the record owner computer 110, the record holder computer 120, the server computer 130, and the recipient computer 140 are depicted in FIG. 1, the record transfer system 100 may include one or more of each of the record owner computer 110, the record holder computer 120, the server computer 130, and the recipient computer 140.

The network 105 may include or be one or more of a local area network (LAN), a wide area network (WAN), a storage area network (SAN), or a combination of these. The network 140 may be wired, wireless, or a combination of these, and may include or be augmented by satellite communications. The network 105 may include or be the Internet. The network 105 may be public or private, or a combination of public and private. The network 105 may be comprised of numerous nodes providing numerous physical and logical paths for data to travel. The network 105 may support one or more well known, proprietary, and other communications protocols, including, for example, Ethernet, the hyper-text transfer protocol (HTTP), the file transfer protocol (FTP), the User Datagram Protocol (UDP), the transmission Control Protocol (TCP), the Internet Protocol (IP), and others. The network 105 may also support secure communications protocols such as, for example, secure HTTP (S-HTTP) and Secure Sockets Layer (SSL).

The record owner computer 110 may typically be a personal computer, and may also be another computing device. The term computing device as used herein refers to any device with a processor, a memory, a storage device, and a network communications unit. The network communications unit allows for communications over network 105 and may support one or more communications protocols, such as, for example, Ethernet, and others. The term computing device includes, but is not limited to, personal computers, server computers, computing tablets, computer workstations, set top boxes, video game systems, personal video recorders, telephones, personal digital assistants (PDAs), portable computers, and laptop computers. These computing devices may run an operating system, including, for example, the Microsoft Windows, Linux, Unix, MS-DOS, Palm OS, and the Apple Mac OS X operating systems. The operating system may include network communications software that allows for communication over the network 105. The network communications software may provide support for communications according to protocols such as UDP, TCP, IP and others. The network communications software may provide support for wired and/or wireless network communications.

A record owner is a person who has ownership of the information contained in the record and may have exclusive control over access to and dissemination of the information contained in the record. The record owner may be the person about whom the record contains information. In another embodiment, the record owner is the person who owns property described in the record. In yet another embodiment, the record owner is a person involved in a transaction, contract or other relationship, personal or business, described in the record. Records as used herein include high school and college transcripts, and may also include loan documents, bank statements, credit card bills, business contracts, notes of indebtedness, deeds, titles, licenses, assignments, certificates, and others.

The record owner computer 110 may include an operating system 111, a web browser 112, and application programs 113. The operating system 111 may be, for example, a version of the Microsoft Windows operating system, or other operating system. The web browser 112 may be a web browser such as Microsoft Internet Explorer, Netscape Communicator, or other web browser. The web browser 112 may provide support for communications via HTTP, S-HTTP, SSL, and other communications protocols. The web browser 112 may allow the record owner computer 110 to communicate over the network 105 with server 130 and other computing devices. The application programs 113 may include an email client such as, for example, Microsoft Outlook, messaging software such as Yahoo! Messenger, and/or other application programs.

The record holder computer 120 is typically a server computer or personal computer or combination of computers in a group, such as a LAN or cluster. The record holder computer 120 may be other types of computing devices. A record holder is an entity that stores and controls access to a record associated with a record owner. Record holders include schools such as high schools, colleges and universities, and may also include banks, insurance companies, doctors, automobile dealers, real estate companies, lawyers, accountants, government agencies or departments (local, state and federal), and others.

The record holder computer 120 may include a web browser 122, an application program 123, a printer driver 125, and a database 124. The web browser 122 may enable the record holder to interact and communicate with the server computer 130 over the network 105. The application programs 123 may be an email client, a messenger program, and other application programs. The database 124 may maintain records associated with record owners 110. The database may be associated with an application program 123 running on the record holder, such as, for example, specialized student information system (SIS) programs and transcript programs used by schools.

The record holder computer 120 may include software for providing some of the functionality and features of the record transfer system described herein. The software may include or be one or more of an application program, a driver, an applet (e.g., a Java applet), a browser plug-in, a COM object, a dynamic linked library (DLL), a script, one or more subroutines, or an operating system component or service.

In one embodiment, a portion of the invention described herein is implemented in printer driver 125. The printer driver 125 may create a printer file format version of a record from the database 124 and transmit the printer file format version of the record to the server computer 130. The printer driver 125 may preprocess and/or preformat one or more records from the database 124. The printer driver 125 may send one or more records to the server computer 130.

The printer driver 125 or other software included with the record holder computer 120 may be stored on a machine readable medium and accessed by a storage device or directly by a processor. The printer driver 125 or other software may be stored on a machine readable medium, including, for example, magnetic media such as hard disks, floppy disks and tape; optical media such as compact disks (CD-ROM and CD-RW) and digital versatile disks (DVD and DVD±RW); flash memory cards; and any other machine readable media. As used herein, a storage device is a device that allows for reading and/or writing to a machine readable medium. Storage devices include hard disk drives, DVD drives, flash memory devices, and others.

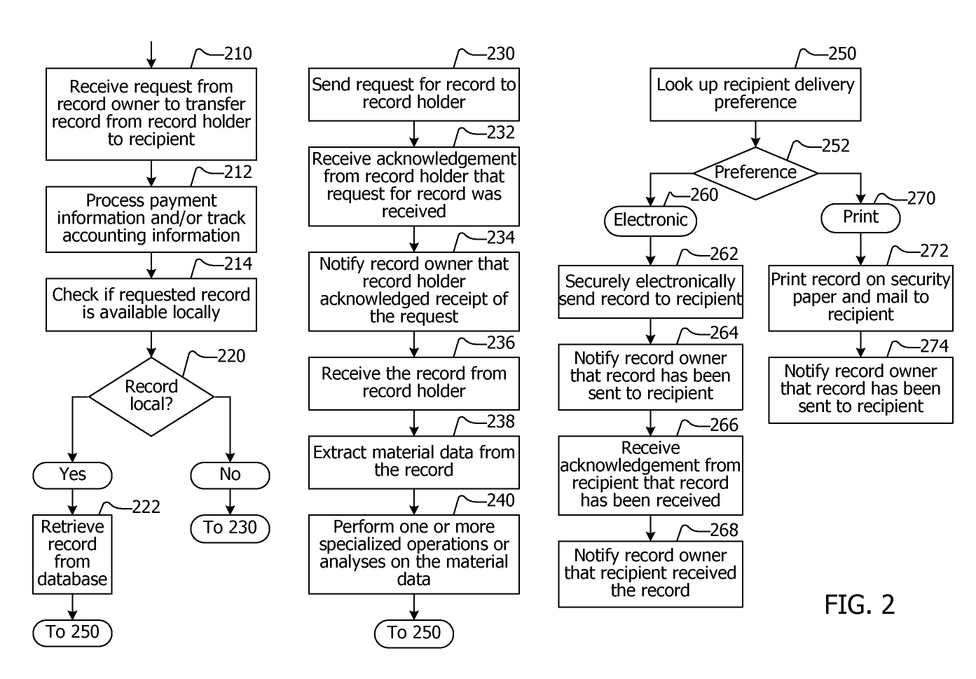

The server computer 130 may include an operating system 131, record transfer software 133, and a database 134. The database 134 may be, as shown, a separate program from record transfer software 133 or may be included in record transfer software 133. Although shown as a single server computer in FIG. 1, the server computer 130 may be two or more server computers and/or other computing devices in a cluster, LAN or other grouping. The server computer 130 may interact with and communicate with the record holder computer 120, the record owner computer 110 and the recipient computer 140 via the network 105. The record transfer software 133 may implement the method described below in FIG. 2.

The record transfer software 133 may be stored on a machine readable medium and accessed by a storage device or directly by a processor.

The recipient computer 140 may include an operating system 141, a web browser 142, application programs 143, and a database 144. The web browser 142 and/or one or more application programs 143 may allow the recipient to interact with and communicate with the server 130 over the network 105. The database 144 may store records provided by the server 130. Alternatively, records may be stored as individual files, may be stored and accessed using a specialized application program, or may be stored and accessed via another application program.

The Methods

Referring now to FIG. 2, FIG. 2 is flow chart of the actions taken by a record transfer system server. The actions described in FIG. 2 may be achieved by software in the form of an application program such as record transfer software 133 described above. Actions ascribed to the “record transfer system server” or the “server” in the discussion of FIG. 2 may be carried out by software such as the record transfer software.

A record transfer system server may receive a record transfer request from a record owner to transfer a record from a record holder to a recipient, as shown in block 210. In one embodiment, the server provides a website through which the record owner may make the record transfer request. The record transfer request may include record owner information, record holder identifying information, and recipient identifying information. The record owner information may include a record owner name, record owner address, record owner identification number such as, for example, a social security number and/or a student identification number, and pertinent date or dates. The pertinent dates may include dates of graduation and dates of enrollment at a school. The record holder identifying information may include a name of a school, an address, a school identification number, and other information. The recipient identifying information may include a name of a school or employer, contact information such as an e-mail or physical address, a school identification number, a contact person, and other information.

To obtain the record request, the server may provide a graphical user interface via a web page using, for example, text entry fields, forms, button, pull down menus, check boxes and other graphical user interface items. The server software may provide a list of participating record holders and/or recipients from which a user may select using the provided graphical user interface. In this embodiment, the record owner may select from participating record holders and recipients in preparing the record transfer request. The request may be received by software running on the record transfer system server. The request may be for the software on server 130 to transfer a record from the record holder computer 120 to the recipient computer 140. The record may be a student transcript. In another embodiment, the record may be a loan document, a medical file or document, property title, credit report, or other information requiring secure delivery. The server may provide a secure connection with the record owner's computer via a web browser to receive the record transfer request over the network over a secure connection. This may be achieved, for example, using S-HTTP and/or SSL.

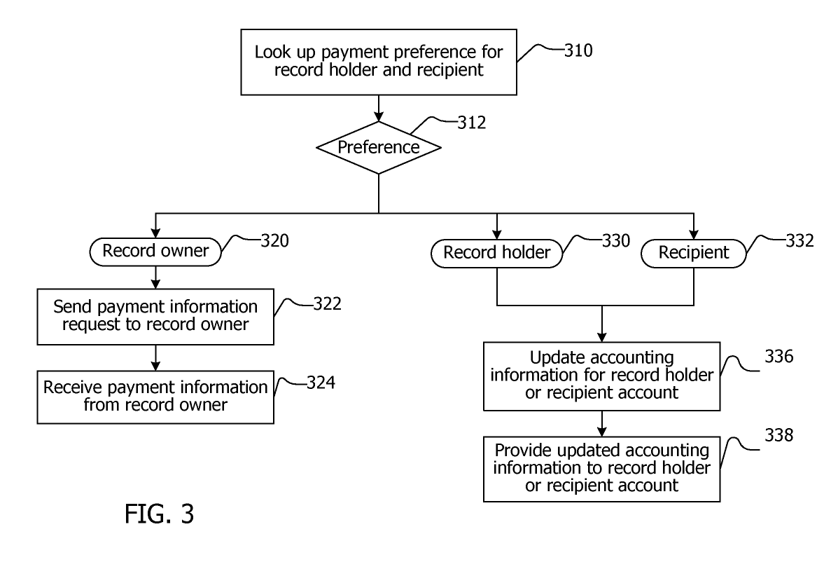

The server may then process payment information and/or track accounting information regarding the request, as shown in block 212. This is described in more detail below regarding FIG. 3.

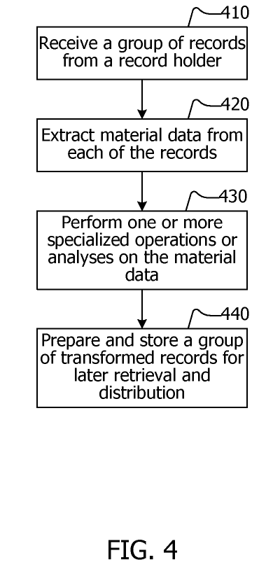

The server may evaluate whether the record is already in its possession, that is, whether the requested record is already stored on the server and is available locally, as shown in block 214. For example, if a record associated with the record owner was previously transferred from a record holder to a recipient, the server may have a copy of the record stored in the database of the server. Group uploading of records by a record holder to the record transfer system is described below regarding FIG. 4. The server may also evaluate if a locally available record is up-to-date, where “up-to-date” may be defined as uploaded within a fixed time period such as with the past month, or as uploaded after event such as the end of the previous grading period, or in some other manner appropriate to the type of record.

If the server is already in possession of an up-to-date version of the record, the record may be retrieved from the server database as shown in block 222, and the process may skip to block 250.

If an up-to-date version of the record is not stored locally as shown in block 220, the flow of actions continues at block 230 in which the server may send a request for the record to the record holder via a secure connection over the network. The request may include all or a portion of the record owner information. The request may include the type and or other identifying information concerning the record requested. For example, the record requested may be a student transcript from years 2000 through 2002, a credit card history from years 1998-1999, or an employment record from 2003.

In one embodiment, the server may send an email note to a designated email address at the record holder instructing the record holder to click on a provided link to a secure website provided by the server. By the record holder accessing the secure website, the server may send the request to the record holder, as shown in block 230. In another embodiment, a record holder may regularly log into a record holder account at a website provided by the server, and the server may provide a message via a pop-up window of the record holder that a record request is pending. Alternatively, the record holder may check a record request status page to learn whether any new requests have been received.

The record holder may process the request received from the server. The record holder may send an acknowledgement to the server that the request for the record has been received. The server may receive the acknowledgement from the record holder that the request for the record has been received, as shown in block 232. The request may be made between software executing on a server computer and software executing on a record holder computer. The software on the server may communicate with software on the record holder which automatically acknowledges receipt of the record request without human intervention. The communications between the server computer and the record holder computer may be secure.

Upon receipt of the acknowledgement, the server may notify the record owner that the record holder acknowledged receipt of the request, as shown in block 234. The server may send this notification to the record owner by email, by updating a status information web page associated with an account that the record owner has on the server, by invoking a pop-up window on the record owner's personal computer or other computing device, by network message, and/or by other techniques. By notifying the record owner that the record request has been acknowledged by the record holder, the need for the record owner to inquire regarding the status of a record transfer request is reduced. By providing the record owner with an acknowledgement that the record transfer request has been received by the record holder, the record owner feels comfortable and confident that the record transfer request is being processed.

The record holder may check a database or specialized application program to determine whether the requested record exists. For example, the record holder may query a database or specialized application program using record owner identifying information, such as, for example, school identification number for the record owner (and/or social security number), the record owner's name and year of graduation, and/or other information provided in the record request. If the record holder determines that there are no records in its database that are associated with the identifier, the record holder may notify the server the requested record cannot be found. In turn, the server may notify the record owner that the record holder cannot locate and does not have the requested record. The acknowledgment and notification in blocks 232 and 234 may inform the server and, in turn, the record owner whether the requested record is available or is unavailable from the record holder.

The record transfer server may request that the record holder accept or deny the request for the record, or state that the record will be provided manually or outside of the record transfer system by the record holder. In this way, the record holder may decide to accept or deny the request for the record and inform the record transfer server of the decision. In this way the record holder may choose to manually print and handle the record transfer request on its own, such as manually printing and mailing the record to the recipient. This functionality and these options may be provided by the record transfer server to the recipient via a user interface on a web page.

If the record holder determines that is has the requested record, the record holder may send the record to the server. The record may be sent securely over the network. Secure transfer of the record may be achieved using a secure communications protocol. Secure transfer of the record may also be achieved by encrypting the record before transferring the record over an insecure communications protocol.

The record holder may send the record as an electronic file. The electronic file may be: (1) in a printer file format such as, for example, a page description language (PDL) including printer control language (PCL) and PostScript; (2) in a readily viewable and printable format such as portable document format (PDF) or Microsoft Word format; (3) a text based file; (4) formatted using a markup language such as the extensible markup language (XML), the Standard Generalized Markup Language (SGML) and the hypertext markup language (HTML); (5) a comma separated variable (CSV) format file; (6) a spreadsheet formatted file such as Microsoft Excel; (7) a proprietary format; or (8) an other file format.

The record transfer may be initiated by the record holder printing the requested record from a student information system software program or other application program. The record holder may select as a printer the “record transfer system.” The record transfer system may provide a printer driver to the record holder. In one embodiment, the printer driver takes the record to be printed and transfers the record to the record transfer system server in a printer file format or other electronic file format. In another embodiment, the printer driver takes the record to be printed, performs some processing on or preformats the record, as described below, and transfers the record to the record transfer system server as an electronic file. As such, the “record transfer system” printer driver is a faux printer driver that serves as a network communication transfer driver. The faux printer driver may encrypt the records before transferring the record to the server. Using other terminology, the faux printer driver is a printer driver to a virtual printer in which the record transfer system is the virtual printer.

The record transfer may also be achieved using a Java applet or browser plug-in that may retrieve a record from an SIS database on the record holder computer and transfer the requested record to the record transfer server.

In another embodiment, the record transfer is achieved through modifications to SIS software. The modifications may be made via additions to or augmentation of the SIS software. The modifications to the SIS software may be made directly in software of the SIS program, may be included in a DLL file referenced by the SIS software, may be included in a plug-in to the SIS software, or other software techniques. The modified SIS software may allow a record holder to transmit one or more records to the record transfer system. In this embodiment, the student information system software may allow the record holder to automatically, regularly send all new records to the record transfer system. This is discussed in more detail below with regard to block record transfers and FIG. 4.

Regardless of the embodiment of that achieves transfer of the requested record from the record holder to the record transfer system, the requested record may be preformatted. That is, the amended SIS software, printer driver, Java applet or other software that transfers the record to the record transfer system server may, before transferring the requested record, preprocess the record to conform to preformatting requirements of the record transfer system. The preprocessing may be performed to preformat the record to conform with a format desired or required by record transfer software on the server.

In one embodiment, the faux printer driver may prepare a PCL or other printer file format version of the requested record and process it to prepare a preformatted requested record. In yet another embodiment, the record may be preformatted by application programs on a record holder computer, such as, for example, student information system software, to conform with a format desired or required by record transfer software on the server.

The preformatted record may include formatting information and material data. Formatting information is information which describes where and how the material data should be displayed on a screen or in a print copy. Formatting information may include location information which describes where the material data is located. Formatting information may include font or typeface information, included graphics, and other characteristics and features used in displaying or printing the record. Material data is substantive information. For example, if the record is a student transcript, material data may include the student's name, social security number, grade point average (GPA), class names, grades, address, school name, and other information. If the record is a loan document, material data may include the record owner's name, social security number, loan amount, property information such as a street address or vehicle identification number, date of origin of the loan, loan company name, loan company address, and other information.

In one embodiment, the preformatting requirements may involve providing a record with location information and material data. The location information may be in the form of (X, Y) coordinates describing where in the record the material data is located. The location information may be in pixels, inches, or other measurement technique. The location information may include offsets or other positioning information. The preformatted record may be created in XML format. When a faux printer driver is used, the preformatted record file may be prepared by extracting material data from a PCL or other printer file format version of a record and preparing location information concerning each of the material data. In another embodiment, the preformatted file may be directly prepared by the modified SIS software, a Java applet or other software.

The requested record may be received at the record transfer system, as shown in box 236. The requested record may be received in preformatted or other format. Upon receiving the record, the server may store the record, such as in a database. In one embodiment, the server decrypts the received record before storing the record. The received record may be preformatted and may include formatting information and material data.

The server may extract material data from the record, as shown in block 238. The server may store the material data extracted from the record in a database along with or in place of received record.

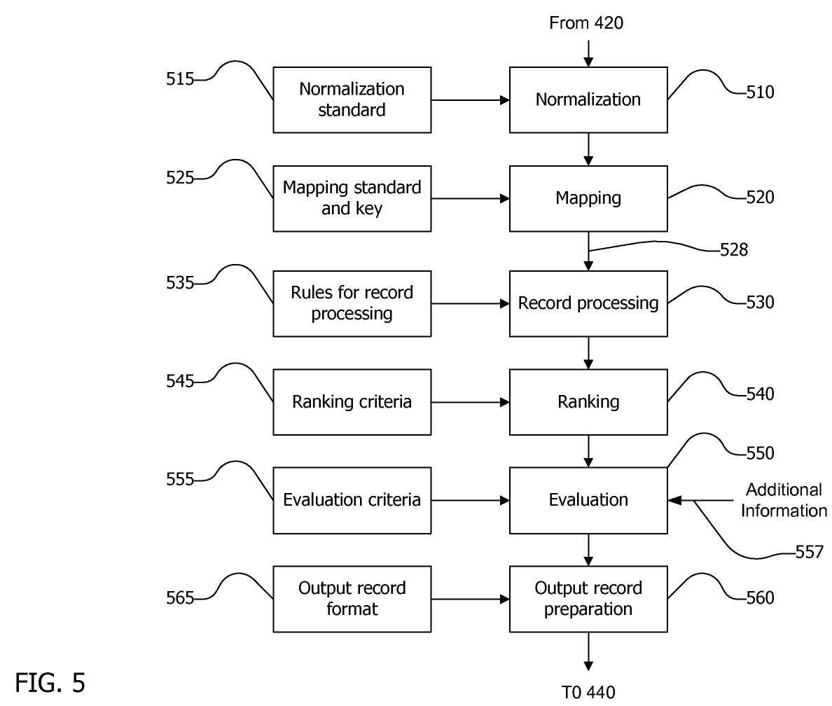

The server may perform one or more specialized operations or analyses on the material data, as shown in block 240. Referring now to FIG. 5, the specialized operations and analyses may include normalizing extracted material data 510, mapping of extracted material data 520, receiver-driven processing of extracted material data 530, ranking the record based on the original and/or normalized material data 540, evaluating the record with respect to evaluation criteria 550, and preparing an output record 560. The specialized operations and analysis may include other operations and analyses not shown in FIG. 5.

At block 510, normalization is a process of modifying the numerical material data to conform to a standard 515. Assume, for example, the record is a student transcript. At least one datum of the material data may be normalized, such as grades, and others. For example, in greater detail, if a grading system of a high school uses a 5.0 scale but the normalization standard is a 4.0 scale, then a grade of 4.5 on a 5.0 scale may be normalized to a 3.6. Similarly, a grade of B+may be normalized to 3.3 on a 4.0 scale. The normalization may take into consideration grading curves that differ between schools in addition to differing grading scales, as well as other differences. The standard for normalization 515 may be provided by an intended record recipient such as a university admissions office, or may be provided by another party such as a state department of education. The normalization to the standard may be based on an algorithm or mapping provided by the record holder. For example, each school or school district may provide a mapping of their grading method against one or more standard grading standards.

Student grades may be normalized using one or more normalization standards provided by a standard-setting authority such as a state department of education or by the intended recipients. An algorithm for normalizing grades may be limited to specific courses, or may apply weighting factors to emphasize some courses over others.

At block 520, mapping is a process of modifying alphanumerical material data to conform to a standard. Again assuming, for example, that the record is a student transcript, mapping may be performed on class names. For example, if the standard name for 9^{th} grade English is “English 100”, then a 9^{th} grade English class with a title “English 232” or “Freshman English” may be mapped to “English 100.” The mapping process may consider factors in addition to course titles. For example, remedial, standard, and honors sections of classes may be mapped differently. Numerical codes may also be used in the mapping such that all of the classes of all schools are mapped to a uniform class coding scheme. Mapping may require both a standard list of class names and a mapping key 525 that relates the class names used by a particular record holder school to the standard names.

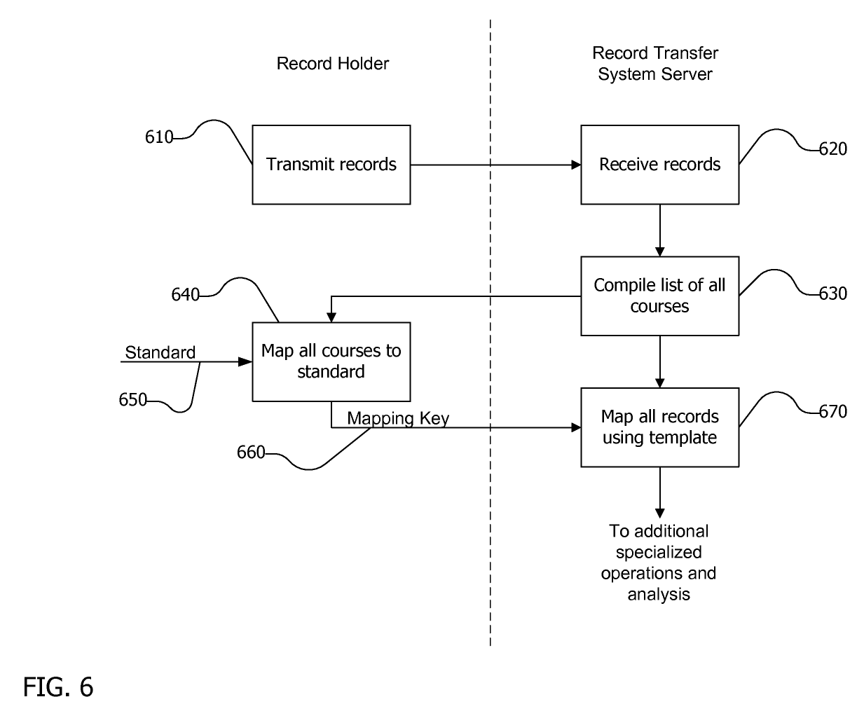

Referring now to FIG. 6, an exemplary process for creating a mapping key begins at block 610 when a record holder transmits a plurality of records which are received by the record transfer system at block 620. In this example, the records are again presumed to be school transcripts. At block 630, the record transfer system server may analyze the plurality of transcripts to compile a list of all of the class names used within the plurality of transcripts. The compiled list of class names may be returned to the record holder school where, at block 640, some or all of the class names are mapped to one of the standard class names 650. A mapping key 660, which maps some or all of the complied list of class names to standard class names 650 may be returned to the record transfer system. At block 670, each transcript may be mapped based on the mapping key provided by the record holder school. When unmapped class names appear on subsequent transcripts, a message may be sent to the school by e-mail or other means requesting that they map the new class to the standard.

Returning to FIG. 5, normalization 510 and mapping 520 may be performed using a normalization standard 515 and a mapping standard 525 provided by a standard-setting authority such as a state department of education. In this case, the modified record 528 after completion of normalization 510 and mapping 520 (which may be performed in either order) may be considered a standardized transformed record.

At block 530, the server may perform specialized record processing in accordance with processing rules 535 provided by the intended record recipient. An example of recipient-driven record processing is the calculation of a grade point average (GPA) in keeping with rules provided by the recipient. The recipient-provided rules may define which course names (from the course mapping standard) will be used for GPA calculation, or how various courses may be weighted to account for course difficulty and other factors. A recipient may define more than one GPA calculation, such as a GPA calculated over all courses and a second GPA value calculated only for selected academic courses.

The recipient-driven processing at block 530 may also include re-mapping of course names and re-normalization of course grades. For example, high school transcripts from various high schools in a first state may be normalized and mapped into a uniform standardized record format 528 using primary standards provided by a standard-setting authority, but may need to be re-mapped and re-normalized to a secondary set of standards before transmission to a university in a different state.

At block 540, the server may also rank all, or a specified set of records based on ranking criteria 545. The ranking criteria 545 may be a proprietary analysis, an algorithm provided by the intended recipient, or another ranking method. Continuing to use the example of student transcripts, the ranking may take into consideration a difficulty level of a class (or the series of classes selected) or department, a competitiveness ranking of the record holder school, normalized and/or original grades, one or more GPA values calculated using recipient-specified rules, and other factors.

At block 550, a record or group of records may be evaluated with respect to one or more evaluation criteria 555. The exact analysis performed may depend on the nature of the evaluation criteria 555. For example, the record under evaluation may be a high school transcript. The evaluation performed at block 550 may be a diploma audit with respect to evaluation criteria 555 in the form of a graduation requirement. Similarly, the evaluation performed at block 550 may be a transcript evaluation with respect to a set of university admissions requirements. In either case, the evaluation criteria 555 may include a list of required or recommended courses, and the evaluation 550 may include comparison of a list of completed courses included in the record with the course list included in the evaluation criteria. The evaluation criteria 555 may include benchmarks for quantitative information such as grade point average and standard test scores, and the evaluation 550 may include comparison of information contained in the record with the benchmarks. The evaluation criteria 555 may include multiple criteria or may be dynamic. For example, when evaluating a high school transcript against university admission requirements, the evaluation may first determine what university degree type is desired or within reach, and then evaluate the transcript against the specific admission requirements for the selected school or program within the university. Where appropriate, additional information 557 such as standardized test scores may be acquired from a data source other than the record holder, matched with records being processed, and integrated into the evaluation 550. The evaluation criteria may also be a university graduation or degree requirement or a post graduate school admission requirement.

The results of the evaluation 550 may indicate the degree of partial completion of a set of requirements contained in evaluation criteria 555 and may identify discrepancies between the record and the requirements. The results of the evaluation 550 may include recommended actions to satisfy the standard. The recommended actions may include a list of courses to be taken along with minimal grades to achieve and other remedial actions such as raising a GPA or retaking a standardized test with the objective of attaining a higher test score.

Normalization, mapping, record processing, ranking, and evaluation may be performed in any combination to modify records to a common standard or to a format requested by the intended recipient. Commonly, normalization and mapping may be performed prior to record processing, and record processing may be performed prior to ranking and evaluation. The recipient may request that some or all records be normalized and/or mapped and/or processed ranked and/or evaluated prior to transfer.

At block 560, each specially processed record may be transformed into an output record format specified by the intended record recipient. The output record may include a transformed version of the original record received from the record holder, and may include all or part of the original record. The output record may include, or be limited to, summary data based on the analysis, ranking, and evaluation of the record. The server may store the output record in addition to or in place of the record received from the record holder, and the server may prepare and store multiple output records derived from each record received from the record holder.

Returning to FIG. 2 at block 250, the recipient may elect to receive the output record electronically or via hard copy. The recipient may make the election during an initial setup with the server or at any time thereafter. The server may store each recipient's preference of whether to receive the output record electronically or via hard copy.

The recipient may specify in what format electronic output records should be provided to it by the server. The format may be based on a template provided by the recipient to the server. The template may specify or otherwise designate a uniform arrangement of information to ease review and/or ease of automated data extraction by the recipient. The electronic output records may be provided by the server to the recipient in recipient preferred file formats such as, for example, PDF, XML, and the Speede TS 130 format. A proprietary format may also be used. In addition, the electronic output records may be provided by the server to the recipient in a graphics format, such as, for example, the Joint Photographic Experts Group (JPEG) format, the Tagged Image File Format (TIFF), the Graphics Interchange Format (GIF), and others.

The output record may be sent either or both by electronic file transfer and/or mail. The server may look up the recipient's preferences to determine whether to send the record in transformed format. The server may also look up recipient delivery preferences to determine whether to send the record electronically or via hard copy, as shown in block 250. In another embodiment, a batch of records may be transferred to a machine readable medium such as, for example, a CD-ROM or DVD-ROM, and mailed to the recipient.

Based on the recipient's delivery preference, as shown in block 252, if the output record is to be sent electronically as shown in block 260, the output record may be sent securely over the network from the server to the recipient, as shown in block 262. Secure transfer of the output record may be achieved using a secure communications protocol. Secure transfer of the output record may also be achieved by encrypting the output record before transferring the record using an insecure communications protocol. Should the server encrypt the output record before delivery, the recipient will need to decrypt the record upon receipt.

After the output record has been sent to the recipient, the server may notify the record owner that the record has been sent to the recipient, as shown in block 264. The server may receive an acknowledgement from the recipient that the output record has been received, as shown in block 266. The server may then notify the record owner that the recipient has acknowledged receipt of the output record, as shown in block 268. The notifications in blocks 264 and 268 may be via email, pop-up window, message, or other notification. Because the record owner is notified that the output record has been sent to the recipient and that the recipient has received the output record, the record owner will not need to contact the record transfer system provider, the record holder, or the recipient by telephone for a status of the record transfer request.

If the output record is to be printed as shown in block 270 and sent via hard copy, the output record may be printed on security paper and sent via mail or other delivery service, as shown in block 272. Security paper may be a proprietary paper with embossing and/or other security information or techniques incorporated therein such as watermarks, thread strands, and others, which are used to verify the authenticity of the record and to prevent fraud.

After the output record has been mailed to the recipient, the server may notify the record owner that the output record has been sent to the recipient, as shown in block 274. The notification may be via email, pop-up window, message, or other notification. Because the record owner is notified that the record has been mailed to the recipient, the record owner will not need to contact the record transfer system provider, the record holder, or the recipient for a status of the record transfer request.

When a recipient is not a subscriber to the record transfer system or has not registered with the record transfer system, the requested output record may nonetheless be sent by mail or securely downloaded to the recipient. This may be achieved using the address or email address provided by a record owner, or may be included in a list of publicly known and available addresses and other contact information for schools, employers, and others. In this way, the record transfer system only requires the registration or membership of the record holder and the record owner.

FIG. 3 is flow chart of the actions taken by a record transfer system server in processing payment and/or accounting information. The server, after receiving a record request or as part of receiving a record request, may look up payment preference information concerning the record holder and the recipient, as shown in block 310. The flow of actions continues based on the payment preference for the record holder or record recipient specified in the record request, as shown in block 312. The record payment preference may designate whether the record owner 320, the record holder 330 and/or the recipient 332 is responsible for paying for the record transfer. In other embodiments, a combination of two or more of the record owner, the record holder and/or the recipient may share in the cost of the record transfer. The sharing of costs may be hidden from a record owner.

If the record owner is responsible for payment for the requested record transfer, the server may send a payment information request to the record owner, as shown in block 322. The payment information request may request that a record owner provide a credit card number, a bank account number, PayPal account number, or other payment information. The payment information request may be made via a web page form, a pop-up window, or other technique. The payment information request includes a cost for transferring the specified record or records from the record holder to the recipient. For example, the cost may be $5, $14, $22 or other amount. The cost may be a flat rate, may be based on the content (that is, the density of information) of the record to be transferred, may be based on the length of the record to be transferred (that is, the number of lines or number of pages), may be based on the number of recipients, and may be derived according to other schemes.

If the record holder or recipient is responsible for payment for the requested record transfers, the cost may be paid per transcript received, per analysis step performed, per output record transmitted, as an annual fixed amount, or some combination of these and other cost basis.

Advertisements, such as for a credit card company, a bank, sporting goods or other goods or services may be included with the request for payment information, notification emails or indirectly through an applet or program triggered by or otherwise associated with or attached to the registration or order process.

The server may receive the payment information from the record owner, as shown in block 324. The payment information may be valid only for a limited time, for example, a day or a week. The server may provide a secure connection with the record owner's computer via a web browser to receive the payment information over the network. The server may communicate with and use the services of a third party to process the payment transaction.

Steps 322 and 324 may be combined and may be included in a web page that the record owner uses to place the record transfer request such as that described with regard to block 210 of FIG. 2.

The responsibility for payment for a record transfer may be based on the relationship between any two or more of the record holder, the record owner and/or the recipient. For example, the payment for the record transfer may be made by the record holder 330 or the recipient 332. This is particularly useful when an employer requires a transcript or medical record of a potential employee during the employment application process. Similarly, some schools may provide as a service to their students free distribution of transcripts. In these embodiments, the server may keep an accounting of the number of records transferred to the recipient and send a bill or accounting to a record holder or a recipient on a regular basis (e.g., monthly or quarterly) for the records delivered. If so, the server may update accounting information for the record holder or the recipient account, as shown in block 336, and provide updated accounting information to the record holder or the recipient, as shown in block 338. The updated accounting information may be provided by mail, by email, or may be provided on a web page on the record transfer system server accessible to the record holder or the recipient. In these embodiments, the record holder or the recipient may pay an annual subscription fee for record distribution, and the annual fee may be for an unlimited umber of record transfers, a certain page amount of record transfers, a certain data amount of record transfer, or an unlimited amount of record transfers. If the annual subscription is not for an unlimited amount of regular transfers, the record transfer system may provide a bill for extension of the record transfer server by email, traditional mail or via a web page.

FIG. 4 is flow chart of the actions that may be taken by a record transfer system server receiving a group of records. The record holder may periodically upload groups or batches of records to the server. The record transfer system may receive a group of records from a record holder, 410. In one embodiment, the received records may be preformatted as described above. The group record transfer may be achieved, for example, by using FTP. In one embodiment, the record holder periodically sends all records requested over a particular period of time such as, for example, every day, once a week, every other week, etc. to the server. In another embodiment, the record holder periodically sends all records newly created on the record holder computer to the server on a regular basis, such as, for example, the record holder may perform a batch upload once a week, once a quarter, at the end of a grading period, at the end of a sales period, after the completion of a series of medical exams or tests, etc. By performing group or batch uploads, the record holder's resources may be utilized more efficiently, and the server may similarly operate more effectively and more efficiently.

After receiving a group of records from the record holder, the server may extract material data from each record, as shown in block 420. The server may perform one or more specialized operations or analyses on the material data, as shown in block 430, to create transformed records. Specialized operations and analyses include normalizing extracted material data, mapping extracted material data, preparing a ranking of the student based on the original and/or normalized material data, evaluating the record with respect to one or more evaluation criteria, and other operations and analyses. The specialized operations and analyses are described in more detail above. The server prepares and stores a group of transformed records for potential later retrieval and distribution, as shown in block 440.

As previously described with respect to FIG. 2, the record transfer process may be initiated by a request from a record owner to transfer a record to one or more record recipients. As an example of this process, a student may request that a high school transcript be transmitted to one or more specific universities. In this case, the record would be subject to specialized operations and processes as requested by each university and delivered in each university's preferred format. Another example of the record transfer system may be for a loan applicant, having submitted a standardized record (i.e. application form), to request that the record be transformed and transmitted to multiple potential lenders. Note in this example, the record owner may also be the record holder. The record transfer process could be used similarly to transmit employment applications to multiple potential employers. In another example of the process, a student, or their parent, may request a transformed version of the student's transcript evaluated against a graduation or admission requirement. In this case, the record owner may also be the record recipient. Many other variations of a record transfer process initiated by the record owner are possible.

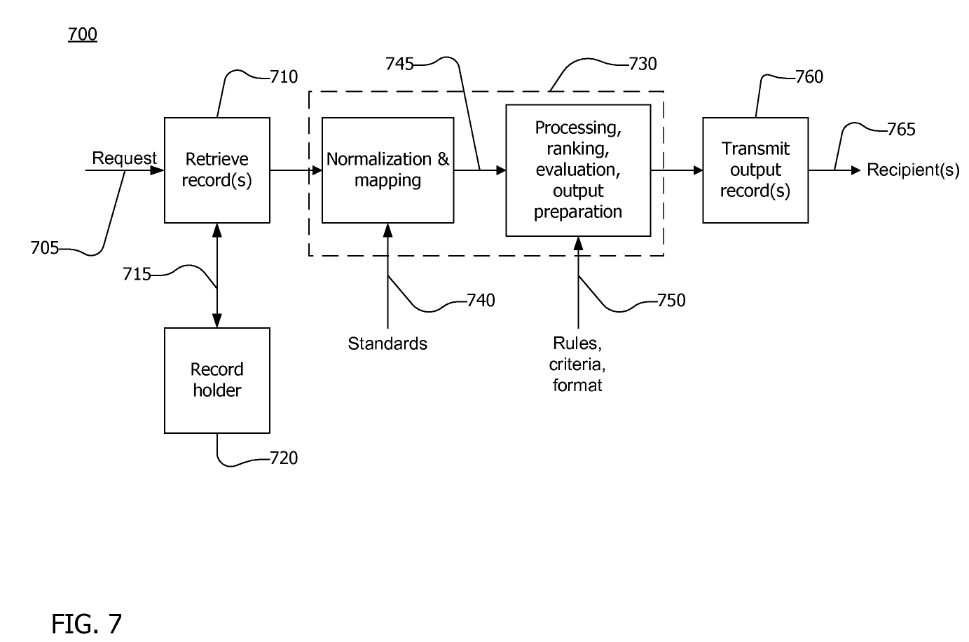

FIG. 7 is a flow chart of a generalized process 700 that may be performed by the record transfer server. The process is initiated when the record transfer server receives a request 705 to transfer one or more records to a recipient. The request 705 may be received from a requester that may be the record owner, as previously shown in FIG. 2, the record holder, the recipient, or another party. The request may be explicit, such as a specific request received over a network, or implicit, such as a contractual requirement to process and transfer blocks of records periodically.

Having received request 705, the record transfer server retrieves the required record or records at block 710. The records may be retrieved from local storage within the record transfer system or, if up-to-date versions of the required records are not available locally, may be requested and received 715 from the record holder 720.

At block 730, the record transfer server may perform specialized operations and analysis as previously described in conjunction with FIG. 5. The specialized operations and processes 730 may include normalization and mapping performed in accordance with standards 740 provided by the intended recipient or by a standard-setting authority. The specialized operations and processes 730 may include record processing, ranking, evaluation, and output record preparation in accordance with rules, criteria, and format requirements 750 received from the intended recipient or recipients. In cases where the records will be sent to multiple recipients, some or all of the recipients may provide different rules, criteria and format requirements. The rules, criteria, and format requirements 750 may be received from each recipient at the time of record transfer, or may be received in advance and stored within the record transfer system.

At block 760, the output record or records are transmitted to one or more recipients 765. In cases where the records will be sent to multiple recipients, the output record format may be different for some or all of the recipients. The recipients may include the record owner, the record holder, the record requester, or other parties designated by the requester.

The process of FIG. 7 may be performed periodically. For example, a record holder such as a school or school district may have the records of all students analyzed at the end of each school year or the end of each grading period. The transformed records may be sent to a higher level organization such as a school district or state department of education, may be sent to the record owners, or may be sent to the record holder. For example, a school or school district record holder may have all high school transcripts evaluated against a high school graduation requirement and/or one or more university admission requirements for use in providing guidance and counseling to the student record owners.

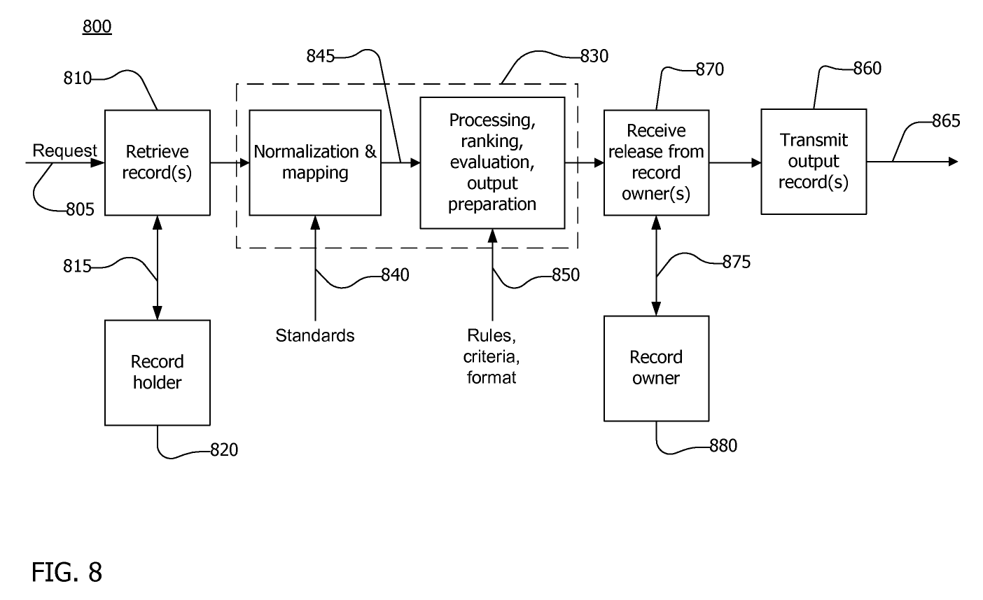

FIG. 8 is a flow chart of another process 800 that may be performed by the record transfer server. The process 800 of FIG. 8 is similar to the process 700 of FIG. 7. Reference designators 805 to 865 in FIG. 8 have the same function as described for reference designators 705 to 765, respectively, in the description of FIG. 7. At block 870, a release from the record owner or owners 880 is requested and received 875 before the records are transmitted 860 to the one or more recipients 865. The release may be received 870 at any point in the process prior to transmission of the records to the recipients. An example of the process of FIG. 8 is transmitting high school transcripts, with the release of the student record owners, to public universities to support the universities' marketing and recruiting efforts.

With regard to FIGS. 2 to 9, additional and fewer steps may be taken, and the steps as shown may be performed in different order, combined or further refined to achieve the methods described herein.

Although exemplary embodiments of the present invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

It is claimed:

1. A method comprising:
receiving over a network from a record holder at least one record in a first format
extracting material data from the at least one record
performing specialized operations and analysis on the material data extracted from the at least one record
creating at least one output record, wherein the at least one output record includes additional data resulting from the specialized operations and analysis
sending the at least one output record to at least one recipient.

2. The method of claim 1, wherein the specialized operations and analysis include one or more of:
normalizing at least some of the material data with respect to a normalization standard to create normalized material data
mapping at least some of the material data in accordance with a mapping standard
record processing at least some of the material data or normalized material data in accordance with rules for record processing
ranking the at least one record in accordance with a ranking criteria using material data or normalized material data
evaluating the at least one record against an evaluation criteria.

3. The method of claim 2, wherein mapping is performed using a mapping key provided by the record holder.

4. The method of claim 2, wherein the rules for record processing, the ranking criteria and the evaluation criteria are specified by the recipient.

5. The method of claim 4, wherein the normalization standard and the mapping standard are provided by a party selected from the group consisting of a standard-setting authority and the recipient.

6. The method of claims 5, wherein
normalizing and mapping are performed in accordance with a primary normalization standard and a primary mapping standard provided by the standard-setting authority
record processing further includes re-normalization and re-mapping in accordance with a secondary normalization standard and a secondary mapping standard provided by the recipient.

7. The method of claim 2, wherein a format of the output record is specified by the recipient.

8. The method of claim 2, wherein the at least one record is a school transcript and the specialized operations and analysis include one or more of:
mapping one or more course descriptions in the transcript to one or more standard course descriptions
normalizing grades included in the transcript with respect to the normalization standard
calculating at least one grade point average in accordance with grade point average processing rules
ranking the transcript with respect to other transcripts in a group of transcripts in accordance with a ranking criteria
evaluating the transcript with respect to an evaluation criteria.

9. The method of claim 8, wherein the evaluation criteria is selected from the group consisting of a high school diploma requirement, a university degree requirement, a scholarship application requirement, a secondary school admission requirement, a university admission requirement, and a post-graduate school admission requirement.

10. The method of claim 8, wherein the grade point average processing rules, the ranking criteria, and the evaluation criteria are provided by the recipient.

11. The method of claim 1, wherein the method is initiated by receiving a request from a record owner to transmit a record to one or more recipients.

12. The method of claim 11, wherein the record owner is also a recipient.

13. The method of claim 1, wherein the at least one record is a plurality of records and the method is initiated by one of the group consisting of: upon request of the record holder, upon request of the recipient, periodically, after the end of a school grading period, and after the end of a school year.

14. The method of claim 13, wherein the record holder is also the recipient.

15. The method of claim 13, wherein the method further comprises:
receiving a release from each record owner of the plurality of records.

16. The method of claim 1, wherein the first format version of the record was prepared by the record holder using a printer driver.

17. The method of claim 1, wherein the first format version of the record was prepared by the record holder using augmented student information system (SIS) software.

18. The method of claim 1, wherein the first format version of the record includes material data and location information.

19. The method of claim 1, wherein the first format version of the record is a markup language version of the record.

20. The method of claim 1, wherein the first format version of the record is a printer file format version of the record.

21. The method of claim 1, wherein the first format version of the record comprises a format selected from the group comprising printer control language (PCL), PostScript, and portable document format (PDF).

22. A computing device comprising:
a processor
a memory coupled with the processor
a network communications unit
a machine readable medium having instructions stored thereon which when executed by the processor cause the computing device to perform actions comprising:
receiving over a network from a record holder at least one record in a first format
extracting material data from the at least one record
performing specialized operations and analysis on the material data extracted from the at least one record
creating at least one output record, wherein the at least one output record includes additional data resulting from the specialized operations and analysis
sending the at least one output record to at least one recipient.

23. The computing device of claim 22, wherein the specialized operations and analysis include one or more of:
normalizing at least some of the material data with respect to a normalization standard to create normalized material data
mapping at least some of the material data in accordance with a mapping standard
record processing at least some of the material data or normalized material data in accordance with rules for record processing
ranking the at least one record in accordance with a ranking criteria using material data or normalized material data
evaluating the at least one record against an evaluation criteria.

24. The computing device of claim 23, wherein mapping is performed using a mapping key provided by the record holder.

25. The computing device of claim 23, wherein the rules for record processing, the ranking criteria and the evaluation criteria are specified by the recipient.

26. The computing device of claim 25, wherein the normalization standard and the mapping standard are provided by a party selected from the group consisting of a standard-setting authority and the recipient.

27. The computing device of claim 26, wherein
normalizing and mapping are performed in accordance with a primary normalization standard and a primary mapping standard provided by the standard-setting authority
record processing further includes re-normalization and re-mapping in accordance with a secondary normalization standard and a secondary mapping standard provided by the recipient.

28. The computing device of claim 23, wherein a format of the output record is specified by the recipient.

29. The computing device of claim 23, wherein the at least one record is a school transcript and the specialized operations and analysis include one or more of:
mapping one or more course descriptions in the transcript to one or more standard course descriptions
normalizing grades included in the transcript with respect to the normalization standard
calculating are least one grade point average in accordance with grade point average processing rules
ranking the transcript with respect to other transcripts in a group of transcripts in accordance with a ranking criteria
evaluating the transcript with respect to an evaluation criteria.

30. The computing device of claim 29, wherein the evaluation criteria is selected from the group consisting of a high school diploma requirement, a university degree requirement, a scholarship application requirement, a secondary school admission requirement, a university admission requirement, and a post-graduate school admission requirement.

31. The computing device of claim 29, wherein the grade point average processing rules, the ranking criteria, and the evaluation criteria are provided by the recipient.

32. The computing device of claim 22, wherein the method is initiated by receiving a request from a record owner to transmit a record to one or more recipients.

33. The computing device of claim 32, wherein the record owner is also the recipient.

34. The computing device of claim 22, wherein the at least one record is a plurality of records and the method is initiated by one of the group consisting of: upon request of the record holder, upon request of the recipient, periodically, after the end of a school grading period, and after the end of a school year.

35. The computing device of claim 34, wherein the record holder is also the recipient.

36. The computing device of claim 34, wherein the method further comprises:
receiving a release from each record owner of the plurality of records.

37. The computing device of claim 22, wherein the first format version of the record was prepared by the record holder using a printer driver.

38. The computing device of claim 22, wherein the first format version of the record was prepared by the record holder using augmented student information system (SIS) software.

39. The computing device of claim 22, wherein the first format version of the record includes material data and location information.

40. The computing device of claim 22, wherein the first format version of the record is a markup language version of the record.

41. The computing device of claim 22, wherein the first format version of the record is a printer file format version of the record.

42. The computing device of claim 22, wherein the first format version of the record comprises a format selected from the group comprising printer control language (PCL), PostScript, and portable document format (PDF).
